(19) United States
(12) Patent Application Publication
(10) Pub. No.: US 2007/0121315 A1
(43) Pub. Date: May 31, 2007

(54) Cosmetic case with light-up compact mirror

(76) Inventor: Yi-Tzu Lan, Zhonghe City (TW)

Correspondence Address: RABIN & BERDO, P.C., Suite 500, 1101 14 Street, N.W., Washington, DC, 20005, US

(21) Appl. No.: 11/288,292

(22) Filed: Nov. 29, 2005

(51) Int. Cl. F21V 33/00

(52) U.S. Cl. 362/135

(57) ABSTRACT

This invention is directed to an apparatus of “cosmetic case with light-up compact mirror”, primarily consisting of an upper cover and a lower cover and having a light source disposed on a pivot joint portion in-between. The light source illuminates the lens in the cosmetic case for the user when facing the mirror within as well as acting as a lighting device in the dark. The characteristic of the invention lies in: said light source is disposed on the interior of the upper cover with the interior hole and the exterior hole both opened at proper positions on the upper cover. The lens is installed on a proper position corresponding to the positions of the interior hole and the exterior hole, comprising of a spotlight portion, a light diffusion portion and a light reflection area. The light diffusion portion is located in the interior hole and the spotlight portion is positioned in the exterior hole, thereby enabling the user to look into the lens like a mirror with better illumination and diffusion of softer light.

### BACKGROUND OF THE INVENTION

I. Field of the Invention

The present invention relates to a device of a “cosmetic case with light-up compact mirror”, in particularly referring to a device that has lens installed on the front end of a light source, enabling the light source to enter the lens and providing a softly spread beams through the reflection and diffusion of light. The invention is able to use for better illumination after the streams of light passing through a spotlight area.

II. Description of the Prior Art

There have been an increase in various cosmetic cases on the market with a light source or a lighting structure designed inside thereof each, such as the “Cosmetic Case Defogger and Lighting Structures” of the Taiwan, R.O.C. Patent No. 368817 (hereafter referred to as the first case), “Mirror and Lighting Device Inside a Cosmetic Case” of the Taiwan, R.O.C. Patent No. 541888 (hereafter referred to as the second case) and “A Cosmetic Case With A Light Source” of the Taiwan, R.O.C. Patent No. M 270712 (hereafter referred to as the third case). The assembly of the components in the first case is very complicated, and a printed circuit board (PCB) is applied to achieve the function, thus increasing the manufacturing cost. In addition, the light source inside the cosmetic case is unable to be used as lighting in the dark, except for lighting the mirror. Although the structure in the second case is more simplified and takes advantage of disposing a circle of lucent portion around the perimeter of the back of a mirror, a plurality of LED or other light sources must be applied to achieve the lighting effect, thus increasing higher manufacturing costs, moreover, the design merely provides as a light source on a mirror without additional lighting function for the user. The third case comprises of the most simplified structure with the lowest costs and the most functions provided therein. With reference to FIG. 1, the third case comprises of a cosmetic case with a light source, and made up of an upper cover a1, a base cover a2, a tray a3 and a light source device a4, which is disposed inside a concave a21 under the bottom of the base cover a2 and is lucent through a hole a22 at a pivot joint portion between upper cover a1 and base cover a2. The concave a21 has a power source a41 of the light source device a4 disposed inside thereof, a switch a42 controlling the switching of the power source a41 is disposed on a side wall outside the base cover a2. When the switch a42 is turned on and the upper cover a1 and the base cover a2 are closed, the beams from the light source device a4 illuminates in the dark directly through the hole a22 at the pivot joint portion between upper cover a1 and base cover a2. When the upper cover a1 and the base cover a2 are opened, the hole a22 is then positioned between the upper cover a1 and the base cover a2, so that the streams of light reflects from the lens from the interior side of the upper cover a1 as a light source for the user to look into the mirror. Nevertheless, such type of light source appears to emit more than a given amount of light, which is harsh to the eyes. Therefore, to solve the problem, the inventor of the third case improves the drawback by disposing attachment lens a23 on the front end of the hole a22, thereby enabling the streams of light emitted from the light source device a4 to have softer focus and diffusion of light effects, thus improving the functions when a user is looking into the mirror inside of the cosmetic case and providing enough brightness in the dark as a lighting lamp, which are lack by the light emitted by the light source device a4 of the third case.

In view of the above, the drawbacks of “a cosmetic case with a light source” is improved by an innovative “cosmetic case with light-up compact mirror”, which takes advantage of a special lens to achieve both functions of changing the brightness of light into soft focus, so as to enable the user to have better illumination when looking into the lens and have better brightness when using the lens as a lighting device. Moreover, the lens of the invention is able to used in a compact container or a compact jewel case.

### SUMMARY OF THE INVENTION

The primary objective of the present invention is to provide a lens structure, which is simplified and easy to be made, providing dual functions of changing the brightness of light acting as either a mirror or a lighting device in line with different requirements of a user.

Another objective of a “cosmetic case with light-up compact mirror” of the present invention primarily comprises of an upper cover, a base cover and a light source. The light source is disposed on the interior of the upper cover. In addition, an interior hole and an exterior hole are respectively opened at proper positions on the upper cover and a lens is installed on a proper position corresponding to the positions of the interior hole and the exterior hole. The lens simultaneously comprises of a spotlight portion, a light diffusion portion and a light reflection area. The light diffusion portion is located in the interior hole and spotlight portion is positioned in the exterior hole, so that the spotlight portion and the light reflection area are both located on the direction of emitting streams of light entered therein. Also, the light reflection area and the spotlight portion both form a certain angle, enabling the direction of reflected ray to level at light diffusion portion.

When the light source switch is turned on and the upper cover is opened for a user to face the lens as a mirror, part of light beams emitted by the light source passes through the light reflection area of the lens and introduce total internal reflection (TIR). This reflects the light diffusion portion on the top, thereby enabling the streams of light to softly diffuse outwards, thus avoiding harsh light shining to the eyes as caused by a conventional structure. Moreover, when the upper cover is closed and the light source is acted as a lighting device, part of the light beams that is emitted by the light source passes directly through, and the other light beams reflect to the light diffusion portion and in turn reflecting to the spotlight area, thus generating more focused rays of light to increase the brightness.

### BRIEF DESCRIPTION OF THE DRAWINGS

FIG. 1 is a three-dimensional explored view of a conventional cosmetic case with a light source.

FIG. 2 is a three-dimensional explored view of the present invention.

FIG. 3 is a three-dimensional perspective view showing the assembly of the present invention.

FIG. 4 is a view of light beams showing the function of the present invention as light on the cosmetic case.

FIG. 5 is a view of light beams showing the function of the present invention as a lighting device.

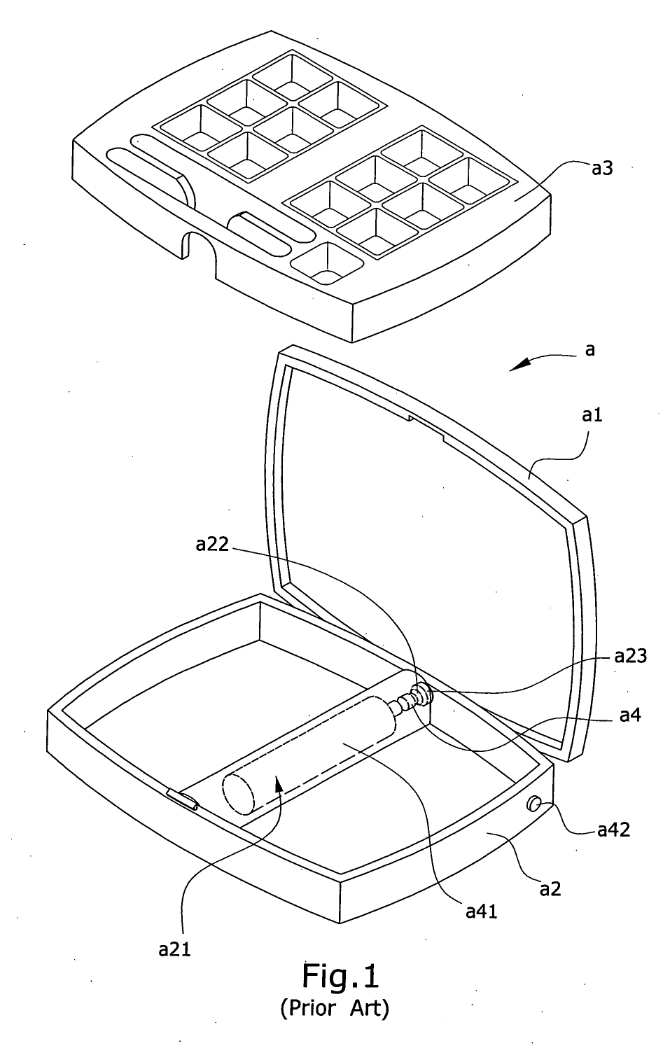

### DESCRIPTION OF THE PREFERRED EMBODIMENT

Further aspects, objects, and desirable features of the invention will be better understood from the detailed description and drawings that follow in which various embodiments of the disclosed invention are illustrated by way of examples.

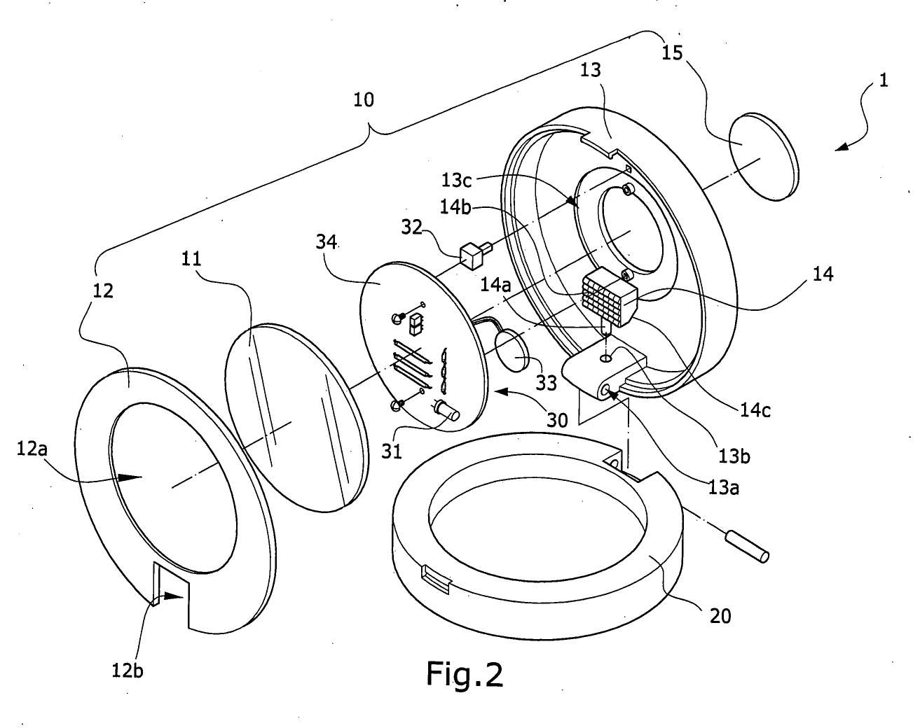

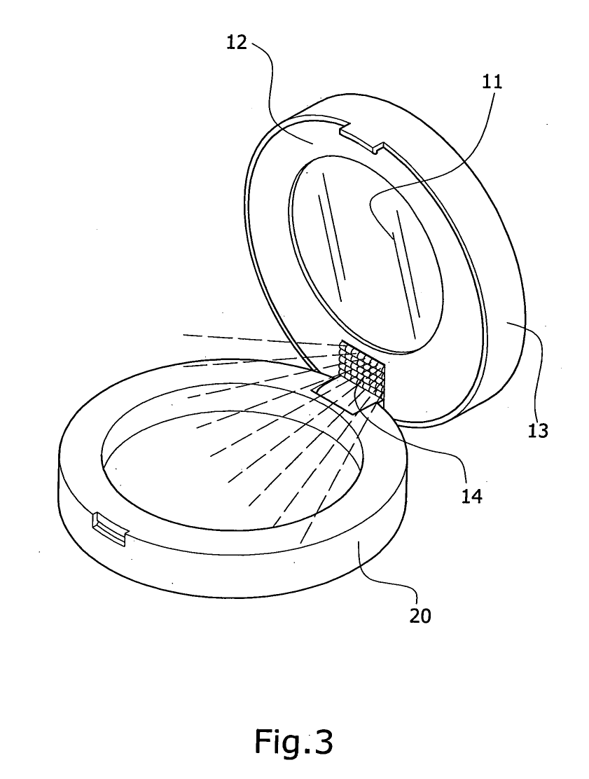

Referring to FIGS. 2 and 3, the cosmetic case with light-up compact mirror in accordance with the present invention primarily includes a cosmetic case 1, which comprises of an upper cover 10, a base cover 20 and a light source 30, wherein:

The upper cover 10 is composed of a lens 11, a lens immovable ring 12, a body 13, a lens 14 and a battery lid 15. The lens 11 is positioned inside an opening 12a in the center of the lens immovable ring 12. An interior hole 12b is disposed on a proper position of the lens immovable ring 12, a pivot joint portion 13a is disposed on the body 13 corresponding to the base cover 20, an exterior hole 13b is disposed on one lateral side of the pivot joint portion 13a. A containing cavity 13c is formed inside the body 13 corresponding to the light source 30 integrating with the battery lid 15. In addition, the lens 14 is disposed on the front end of the containing cavity 13c, simultaneously comprises a spotlight portion 14a, a light diffusion portion 14b and a light reflection area 14c, where the light diffusion portion 14b is positioned inside the interior hole 12b and the spotlight portion 14a is positioned inside the exterior hole 13b. The spotlight portion 14a and the light reflection area 14c are both positioned where light is emitted through.

The light reflection area 14c and the spotlight portion 14a both form a certain angle, enabling the direction of reflected ray to level at light diffusion portion 14b;

The base cover 20 is used to contain cosmetics, such as lipsticks, eye shadows or powder blusher etc., a pivot joint portion 21 is disposed corresponding to the position of the upper cover 10.

The light source 30 having a LED or a traditional bulb 31, a switch 32 and a power source 33 providing electric power disposed on the circuit board 34, and the circuit board 34 is positioned inside the containing cavity 13c of the upper cover 10.

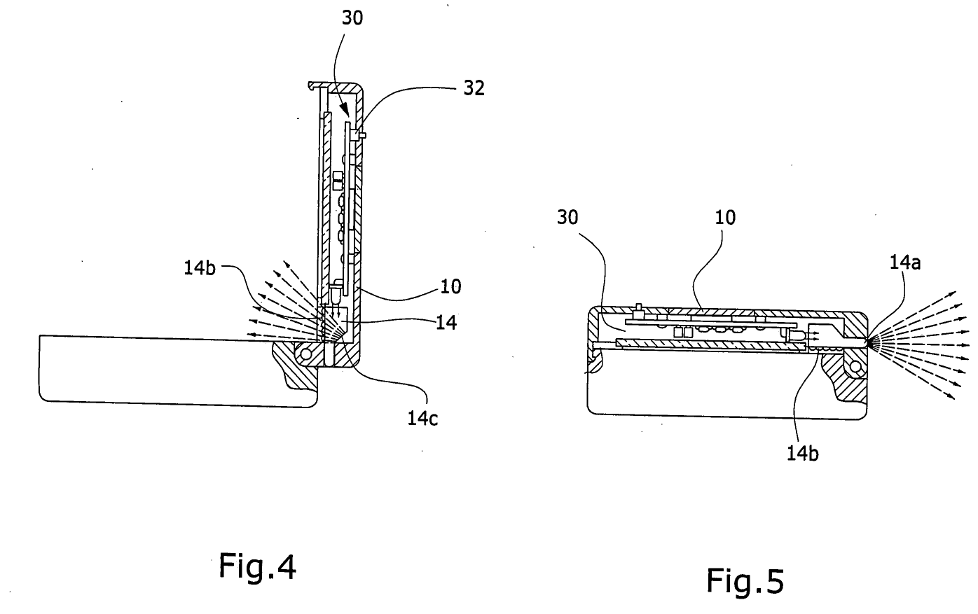

With reference to FIGS. 4 and 5, when switch 32 of the light source 30 is turned on and the upper cover 10 is opened for the user to use the lens as a mirror. Part of light beams emitted by the light source 30 passes through the light reflection area 14c of the lens 14 and introduce total internal reflection (TIR), thus reflecting to the light diffusion portion 14b on the top, thereby enabling the streams of light to diffuse softly outwards. When the upper cover 10 is turned off and the light source 30 is acted as a lighting device, part of light beams emitted by the light source 30 passes through spotlight area 14a. In addition, when the upper cover 10 is closed, part of light beams emitted by the light source 30 reflect onto the light diffusion portion 14b and then reflect to the spotlight area 14c, thus generating more focused rays of light to increase the brightness.

In conclusion, the lens is able to used inside a compact container or a compact jewel case with a light source, enabling the user to look into the lens as a mirror with better illumination or doubling as a lighting device. The invention possesses the characteristic of changing the brightness of light in line with different requirements of a user.

In summary, the present invention is related to a “cosmetic case with light-up compact mirror” taking advantage of the change in brightness of lens, so that the streams of light emitted by the light source enables the user to look in the lens or better performance in illumination for the user. The invention possesses the effect of changing the illumination with the practicability and the advancement compared with other devices of the same kind.

Accordingly, the practical applications mentioned above are some of the best applied examples of the present invention. Alternation and modification in accordance with the present invention should involve into the patent range of the present invention. Many changes and modifications in the above-described embodiments of the invention can, of course, be carried out without departing from the scope thereof. Accordingly, to promote the progress in science and arts, the invention is disclosed and it's intended to be limited only by the scope of the appended claim.

What is claimed is:

1. A “cosmetic case with light-up compact mirror” primarily comprises of an upper cover, a base cover and a light source. The light source is used to illuminate the lens inside the cosmetic case to be faced by the user as well as serve as form of lighting in the dark. The improvement is characterized by: disposing light source inside the upper cover by opening an interior hole and an exterior hole at proper positions on the upper cover. Lens is then installed on a proper position corresponding to the positions of the interior hole and the exterior hole; said lens comprises of a spotlight portion, a light diffusion portion and a light reflection. The light diffusion portion is located in the interior hole and the spotlight portion is positioned in the exterior hole; spotlight portion and light reflection area are both located in the direction of emitted streams of light, in addition, the light reflection area and the spotlight portion both form a certain angle, enabling the direction of reflected ray beams to level at said light diffusion portion.

2. The “cosmetic case with light-up compact mirror” of claim 1, wherein the light source is able to be a LED.

3. The “structure of generator/motor” of claim 1, wherein the light source is able to be a traditional bulb.

4. The “cosmetic case with light-up compact mirror” of claim 1, wherein the lens is used in a compact container with a light source.

5. The “cosmetic case with light-up compact mirror” of claim 1, wherein the lens is used in a compact jewel case with a light source.
